(19) United States
(12) Patent Application Publication
(10) Pub. No.: US 2019/0171774 A1
(43) Pub. Date: Jun. 6, 2019

(54) DATA FILTERING BASED ON HISTORICAL DATA ANALYSIS

(71) Applicant: Promontory Financial Group LLC, Washington, DC (US)

(72) Inventors: Joshua N Andrews, Centennial, CO (US); Thomas C Wisehart, JR., Centennial, CO (US)

(21) Appl. No.: 15/830,168

(22) Filed: Dec. 4, 2017

(51) Int. Cl. G06F 17/30; G06N 99/00; G06Q 30/02

(52) U.S. Cl. CPC G06F 17/30967; G06Q 30/0201; G06N 99/005

(57) ABSTRACT

A method, system, and computer program product for data filtering based on historical data analysis. A first document is identified based on keywords extracted from input. The first document is converted into a multi-dimensional vector based on analyzing a set of features of the first document. The converted multi-dimensional vector is assigned to at least one machine learning cluster in which the at least one machine learning cluster is formed based on historical data derived from previously processed documents. A set of task items linked to the at least one machine learning cluster is retrieved. The set of task items to the first document is associated.

### TECHNICAL FIELD

The present invention relates generally to a method, system, and computer program product for data filtering based on historical data. More particularly, the present invention relates to a method, system, and computer program product for keyword extraction and historical data analytics based data filtering.

### BACKGROUND

Historical analytics refers to the analysis of activity and data from the past to discern particular trends, patterns, correlations, and other statistical relationships that may drive insight into business performance. At times, data obtained from historical analytics may be applied to existing enterprise software systems, in order to ensure that operational activities of organizations are optimized to generate better results and minimize risk.

An organization can offer various products to their customers in order to provide the most appropriate service that will fit its customers' needs. Each product typically covers a set of features, some of which may be distinct from other products. Because of this, each product may impose different types of requirements and resources on the organization. These different types of requirements and resources are also associated with their own risk levels and impact the overall system risk for the organization.

### SUMMARY OF THE INVENTION

The illustrative embodiments provide a method, system, and computer program product. An aspect of the present invention identifies a first document based on keywords extracted from input. The aspect of the present invention converts the first document into a multi-dimensional vector based on analyzing a set of features of the first document. The aspect of the present invention assigns the multi-dimensional vector to at least one machine learning cluster in which the at least one machine learning cluster is formed based on historical data derived from previously processed documents. The aspect of the present invention retrieves a set of task items linked to the at least one machine learning cluster. The aspect of the present invention associates the set of task items to the first document.

An aspect of the present invention includes a computer program product. The computer program product includes one or more computer-readable storage devices, and program instructions stored on at least one of the one or more storage devices.

An aspect of the present invention includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example data filtering based on historical data analysis in accordance with an illustrative embodiment;

FIG. 4 depicts a block diagram of an example implementation of data filtering based on historical data analysis in accordance with an illustrative embodiment; and

FIG. 5 depicts a flowchart of an example process for data filtering based on historical data analysis in accordance with an illustrative embodiment.

### DETAILED DESCRIPTION OF THE EMBODIMENTS

Illustrative embodiments recognize that several entities operate in an environment where regulatory activities are prevalent. Regulations issued by different categories of entities such as Consumer Financial Protection Bureau and Office of Foreign Asset Control are increasing exponentially on a daily basis, and most of these rules and regulations by the entities impose compliance obligations on the entities when they conduct their business operations. Illustrative embodiments recognize that entities in some industries face numerous compliance obligations at the entire entity level, whereas other entities need to address compliance obligations only when they conduct a specific subset of their business activities. Illustrative embodiments further recognize that some entities may provide a set of products and services that may be regulated more than the entities' other products and services. Illustrative embodiments recognize that an entity's failure to implement or follow relevant compliance obligations may lead to negative consequences, ranging from sanctions to being barred from operating in a business space altogether.

Illustrative embodiments recognize that the entities have a difficult time keeping up the ever-increasing number of compliance obligations. In addition to newly announced regulations which trigger additional compliance obligations, illustrative embodiments also recognize that existing regulations may be amended by adding or revising certain language, which may likely lead to additional compliance obligations. Illustrative embodiments also recognize that existing regulations may be removed in part or altogether, which may result in certain compliance obligations to be outdated.

With an increasing number of applicable compliance obligations, illustrative embodiments recognize that entities have leveraged software systems to monitor, select, and certify their level of compliance with the obligations. For example, a database can store a compilation of compliance obligations which are assigned to a set of business categories and provide summaries of the obligations along with the regulations to which the obligations relate. Illustrative embodiments recognize that compliance obligation software systems can be incorporated into a risk assessment software to evaluate operational risk exposed to an entity based on the extent of the compliance obligations as well as a set of recommendations it needs to follow in order to reduce such operational risk. Further, illustrative embodiments recognize that these software systems may identify and assign action items to a compliance obligation. For example, Federal Deposit Insurance Corporation (FDIC) provides Dodd-Frank regulations that require a compliance obligation of conducting annual stress tests for financial institutions having assets above a certain value. A compliance obligation software system identifies a set of action items, such as gathering baseline stress test scenarios and reporting to FDIC, and assigns the set of action items to the compliance obligation resulting from the Dodd-Frank regulations. In this manner, an entity may streamline the process of staying current with its compliance obligations and can be confident that it will avoid adverse regulatory actions.

Illustrative embodiments recognize that every entity is different in terms of its nature of business and types of transactions. Accordingly, existing compliance obligation software systems allow the entity to select applicable obligations and action items. For example, consider a compliance obligations library database which compiled all compliance obligations for a first business category including summaries of the compliance obligations along with the regulations to which the obligations relate. In this example, the database can be leveraged by a user to execute database queries and select a subset of the compliance obligations that are relevant to the entity and its activities, including business transactions conducted by the entity and/or products and services offered by the entity. Illustrative embodiments recognize that the ability to customize compliance obligation software systems enables a robust environment in which unnecessary memory space is saved by only allowing retrieval of relevant data, e.g., compliance obligations data.

Illustrative embodiments recognize that selecting applicable action items to be associated with compliance obligations is generally a manual operation. This requires a commitment of significant entity resources, which can be disruptive and time-consuming for entities to implement properly. This problem becomes far more complicated especially in light of existing tens of thousands of compliance obligations, scores of new compliance obligations imposed on a daily basis, compliance obligations removed due to certain deregulations, and updated compliance obligations based on amended regulations. Illustrative embodiments also recognize that replacing manual operation of selecting applicable action items is a significant technological challenge since each compliance obligation provides layers of complexity based on the category of the entity, the products and/or services being offered by the entity, and the business activities conducted by the entity. Illustrative embodiments thus recognize that manual selection of action items applicable to each entity can be inefficient and ineffective, yet properly analyzing the regulation from which the obligation is based and evaluating the entity's business structure and the process can be a complex process.

The illustrative embodiments recognize that the presently available tools or solutions do not address the needs or provide adequate solutions for these needs. The illustrative embodiments used to describe the invention generally address and solve the above-described problems and other problems related to the automatic selection of data items based on keyword extraction and historical data analysis.

An embodiment can be implemented as a software application. The application implementing an embodiment can be configured as a modification of an existing software platform, as a separate application that operates in conjunction with an existing software platform, a standalone application, or some combinations thereof.

In one embodiment, the system enables action-level filtering based on the obligations to which the entity is required to comply. That is, a set of actions items can be automatically determined and populated based on a set of compliance obligations identified for the entity. When the user initiates a process to select and filter the action items to be performed by the entity to comply with its obligations, an embodiment of the present invention identifies a set of obligations associated with the entity, e.g., a business organization. In one embodiment, the set of compliance obligations can be identified based on the identity of the entity. In another embodiment, the set of compliance obligations can be identified based on the products and services offered by the entity. In yet another embodiment, the set of compliance obligations can be identified based on the activities conducted by the entity. Content in each of the set of compliance obligations can be parsed then mapped to an aspect of the entity, including but not limited to the type and size of the entity, the volume of transactions conducted by the entity, and any sub-entities that exist under the entity. In some embodiments, the set of compliance obligations can be identified based on analyzing historical data, including any compliance obligations previously assigned to other entities that are similar to the entity being scrutinized.

In one embodiment, a set of action items that are tagged to the identified set of obligations is determined. In some embodiments, a set of action items are determined based on historical data that were previously tagged to the identified set of compliance obligations. In one embodiment, keywords in compliance obligations are identified and the keywords are used to construct a query to generate the set of action items. For example, a keyword “stress test” is extracted from a first compliance obligation, which is converted into a database query such as an SQL query SELECT*IN TASKS_DATABASE WHERE Tag IN (“stress test”). Any action items retrieved from the database query are tagged to the first compliance obligation. In one embodiment, the set of action items tagged to the identified set of compliance obligations are presented to the user via a graphical user interface. In this embodiment, the subset of action items can be selected by the user, such as a user using a filtering function from the set of action items.

Another embodiment of the present invention automatically links the compliance obligations to the set of action items, as the obligations are entered into the system. In some embodiments, the existing set of action items tagged to the compliance obligations can be added or removed in response to the compliance obligation being updated or removed from the database. In these embodiments, changes to the set of compliance obligations are detected and a new keyword is generated based on the delta to the set of compliance obligations. The keyword is used to generate a second database query which retrieves a second set of action items that can be present to the user via a graphical user interface.

The illustrative embodiments are described with respect to certain types of action items, database queries, compliance obligations, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

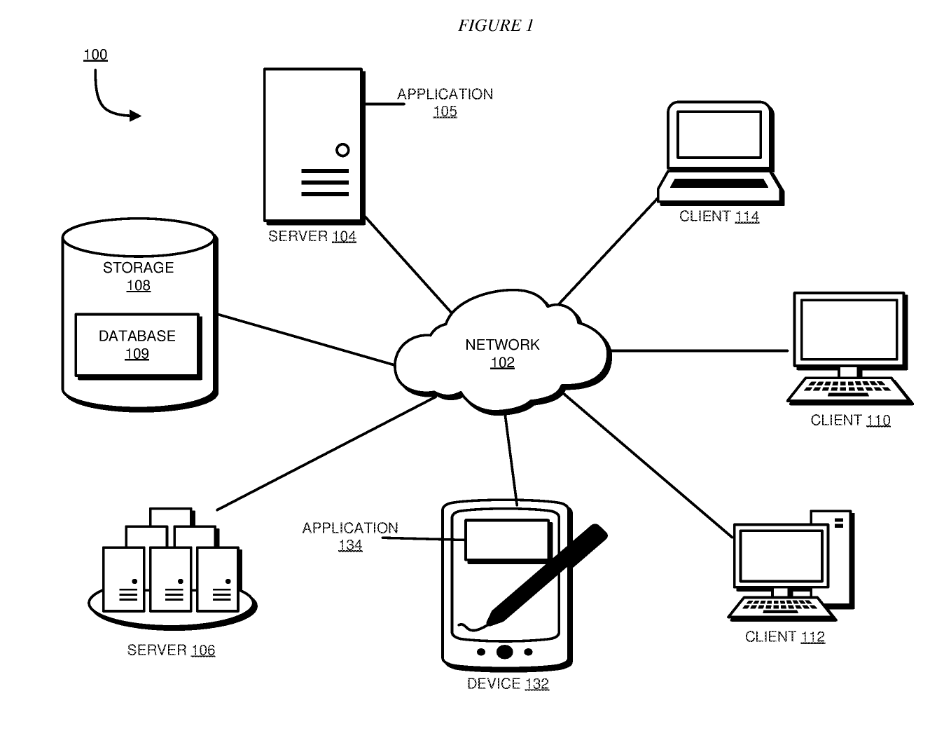

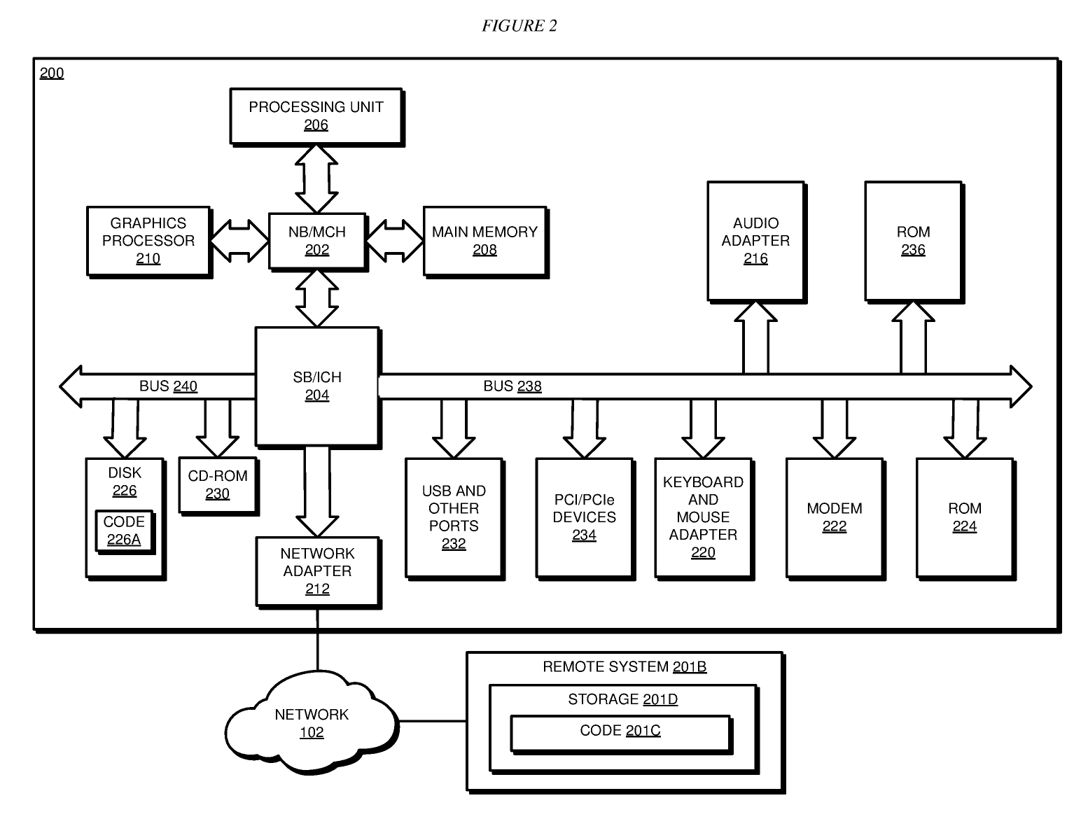

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 alone, application 134 alone, or applications 105 and 134 in combination implement an embodiment described herein. Channel data source 107 provides the past period data of the target channel or other channels in a manner described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 and/or application 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

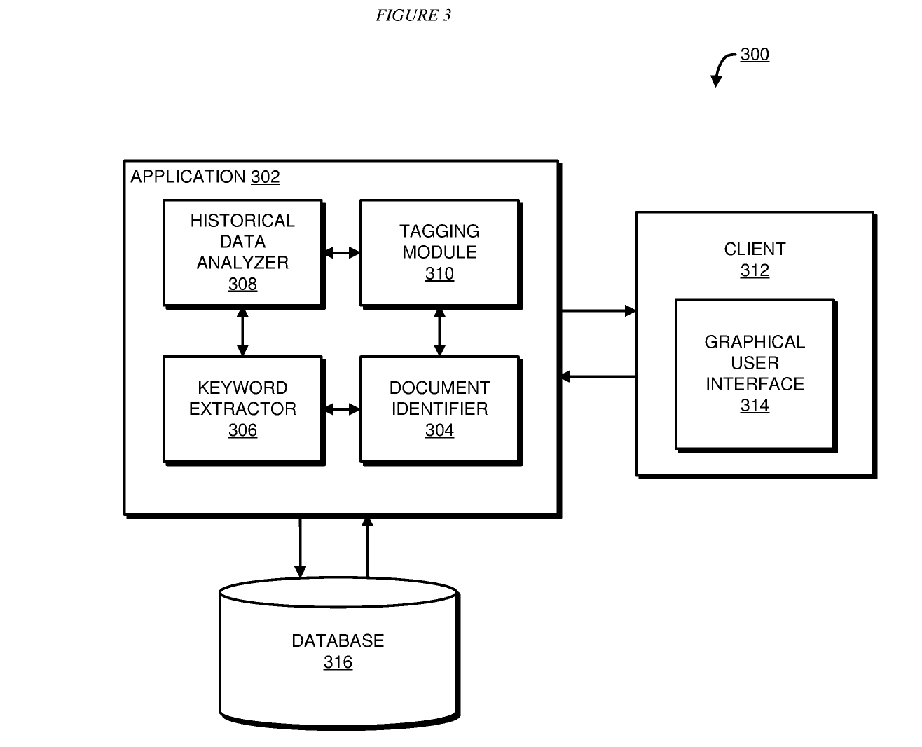

With reference to FIG. 3, this figure depicts a block diagram of an example data filtering based on historical data analysis in accordance with an illustrative embodiment. Application 302 is an example of application 105 in FIG. 1. Client 312 is an example of any of clients 110, 112, and 114 in FIG. 1. Database 316 is an example of database 109 in FIG. 1.

Application 302 includes document identifier 304, keyword extractor 306, historical data analyzer 308, and tagging module 310. Document identifier 304 receives entity information from client 312 through graphical user interface 314. In one embodiment, entity information may be a type or category of an entity, including the industry in which the entity operates. For example, a category of entity may include banking or financial entity that is a public corporation. In some embodiments, the type of an entity may include the size of the entity which can be categorized by the number of employees or the size of the revenue. It can be noted that the set of compliance regulations are often identified based on the size of the entity, depending on its number of employees or revenue figures. In one embodiment, entity information may also include activities performed by the entity. Activities of an entity may include types of business operations in which the entity participates. Referring to the previous example, the activities of a public banking corporation may include lending and exchanging currency. In some embodiments, the activities of an entity may include geographical regions in which the entity operates and the volume of the activities that the entity performs during a predetermined period. In one embodiment, entity information may include entity assets. In some embodiments, entity assets may include products and services provided by the entity. For example, entity assets may include word processing products offered by an information technology company. In one embodiment, entity information may also include entity description, which may be a text description providing different aspects of the entity.

In one embodiment, document identifier 304 analyzes the entity information entered via user input and identifies a set of documents that are relevant to the entity. In some embodiments, document identifier 304 accesses database 316 to retrieve previous records associated with other entities that may have overlapping entity information as the entity information entered by the user. If so, document identifier 304 retrieves the set of documents for such entity. In other embodiments, document identifier 304 constructs at least one database query based on the entity information and retrieves the documents based on the at least one database query. In these embodiments, the constructed database query can be based on the type of entity, entity activities, entity assets, and entity description. For example, document identifier 304 may construct a database query such as SELECT*FROM Documents WHERE type=“Finance” AND size>=100, if the entity information indicates that the category of the entity is a bank and the size of the revenue exceeds 100 million. In some embodiments, document identifier 304 may construct a first database query that includes the least restrictions and filter the first results by constructing subsequent database queries until the retrieved documents are under a threshold value. In other embodiments, document identifier 304 may construct a first database query that is most restrictive, and, in response to the number of retrieved documents under a threshold value, remove at least one restriction (e.g. WHERE size>=100) until the number of retrieved documents exceeds the threshold value. In several embodiments, document identifier 304 may construct a database query on the subset of documents first identified through parsing previous records associated with other entities that may have overlapping entity information as the entity information entered by the user.

In some embodiments, document identifier 304 receives the user input through graphical user interface 314 and may perform natural language processing to be consumed by application 302, including historical data analyzer 308 and keyword extractor 306. In this embodiment, document identifier 304 may parse the text corpus of the user input, including entity description, and may output various analysis formats, including part-of-speech tagged text, phrase structure trees, and grammatical relations (typed dependency) format. In some embodiments, natural language processing algorithm can be trained through machine learning via a collection of syntactically annotated data such as the Penn Treebank. In one embodiment, document identifier 304 may utilize lexicalized parsing to tokenize data records then construct a syntax tree structure of text tokens for each of data record. In another embodiment, document identifier 304 may utilize dependency parsing to identifying grammatical relationships between each of the text tokens in each of the data records.

Keyword extractor 306 receives the documents retrieved by document identifier 304 and extracts a set of keywords from the documents. In several embodiments, the retrieved documents may be unstructured data, e.g. compliance obligation documents, in which keyword extractor 306 parses for the relevant data to generate the set of keywords for generating a database query for action or task items. In one embodiment, keyword extractor 306 identifies the most frequently occurring keyword and constructs the database query based on the keyword. For example, keyword extractor 306 parses through a set of documents and removes any keywords from consideration such as “a”, “the”, “for”, and “to” based on a dictionary database, e.g. database 316, which provides such to-be-ignored keyword list. Then, keyword extractor 306 identifies the most frequently appearing keywords. For example, keyword extractor 306 may extract a keyword “stress test” from a first compliance obligation involved with reporting requirements under the Dodd-Frank Act, which is converted into a database query such as an SQL query SELECT*IN TASKS_DATABASE WHERE Tag IN (“stress test”). In some embodiments, keyword extractor 306 may determine a set of rules that provide how many keywords are to be extracted, such as selecting the top five most frequently occurring keywords from the set of documents retrieved by document identifier 304.

In other embodiments, keyword extractor 306 may extract the keywords based on unstructured data by executing a keyword search algorithm such as pointwise mutual information (PMI) algorithm. In this embodiment, keyword extractor 306 identifies a first keyword and assigns a (PMI) score based on the frequency of the first keyword appearing in a first document which does not otherwise appear in other documents. Keyword extractor 306 iterates through all documents to identify the remaining keywords and assign the PMI scores as provided above. After the iteration is complete, keyword extractor 306 ranks the identified keywords based on the assigned PMI scores and generates a set of risk identifier tags based on the ranked keywords. Once the keywords are extracted and the database query is constructed, keyword extractor 306 executes the database query on task database, e.g. database 316, to retrieve a set of tasks to be tagged with each document of the set of documents retrieved by document identifier 304.

Historical data analyzer 308 receives a set of documents retrieved by document identifier 304 and performs data mining algorithms on historical data to determine a set of task items to be tagged with each of the received documents. In one embodiment, historical data analyzer 308 retrieves historical data including a set of documents and task items tagged to each document within the set. Historical data analyzer 308 generates a decision tree structure based on historical data, which ultimately categorizes incoming data into different classes. Once the decision tree structure is generated, historical data analyzer 308 receives the set of documents retrieved by document identifier 304 and perform a traversal of the generated decision tree for each document within the set of documents. The traversal of the decision tree results in each document being classified, and historical data analyzer 308 determines a set of task items based on the classification of the document. In one embodiment, historical data analyzer 308 repeats the traversal for each document until the task items are determined based on the classification of every retrieved document within the set.

In another embodiment, historical data analyzer 308 determines a plurality of cluster values, each of the centroid values representative of task items associated with the document cast as multi-dimensional array values. As historical data is being called by database 316, historical data analyzer 308 assigns each document in historical data with its own multi-dimensional array value (training data) based on the task items assigned to such document in historical data. Once all documents in the historical data is assigned with the training data, historical data analyzer 308 plots the training data and cluster values on a graph and forms machine learning clusters based on the proximity of the training data and the cluster values. In some embodiments, the multi-dimensional array values in the cluster values may be adjusted based on the training data into which the cluster values formed the cluster. Thereafter, historical data analyzer 308 assigns each machine learning cluster with a set of task items. In one embodiment, historical data analyzer 308 categorizes each document within the set of documents retrieved by document identifier 304 to at least one machine learning cluster then determines the task of items assigned to the historical data cluster.

In yet another embodiment, historical data analyzer 308 may access database 316 to retrieve a plurality of historical datasets to generate a set of rules in which task items can be identified. In some embodiments, historical data analyzer 308 generates a set of candidate rules based on the associative relationships of data between each task items associated with the documents. Based on the candidate rules, historical data analyzer 308 determines whether each candidate rule exceeds a predetermined minimum support value, which determines how often a candidate rule is applicable to a historical data, and a predetermined minimum confidence value, which determines how often associative relationships as represented in a candidate rule appears on the historical data. If a candidate rule exceeds both minimum support and confidence thresholds, historical data analyzer 308 stores the candidate rule. If a candidate rule does not exceed either minimum support or confidence thresholds, historical data analyzer 308 discards the candidate rule. In several embodiments, historical data analyzer 308 may utilize any of these three historical data analytics algorithms to determine the set of task items to be tagged with each of the received documents.

Once the task items for each retrieved document is determined, tagging module 310 may associate the task items with each of the document. In one embodiment, tagging module 310 may convert task items into pointer values and link the pointer values with the retrieved document. In another embodiment, tagging module 310 may store and index retrieved document and pointer values together into a single data structure, including but not limited to a tree structure and map structure. In several embodiments, tagging module 310 allows client 312 to retrieve all documents retrieved based on user input, e.g. entity information, and all the task items associated with such documents. In one embodiment, tagging module 310 may allow graphical user interface 314 of client 312 to further filter the documents and/or task items in order to ensure that all documents and task items are relevant to the entity information. In some embodiments, manual filtering through graphical user interface 314 may be stored and used as additional training data for historical data analyzer 308.

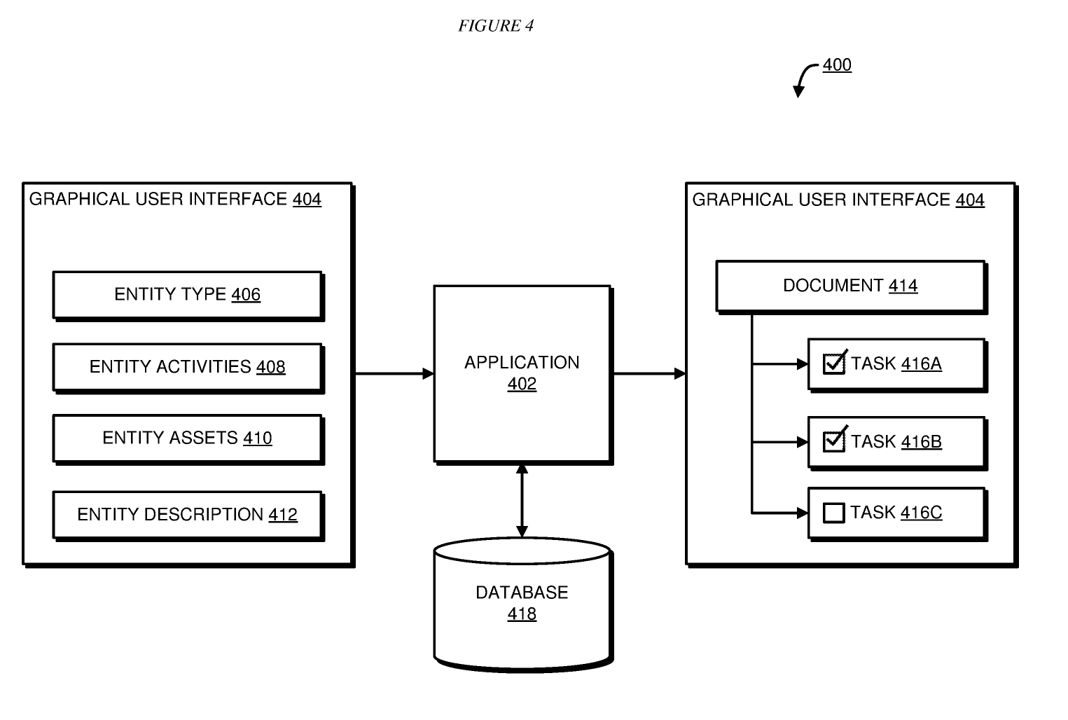

With reference to FIG. 4, this figure depicts a block diagram of an example implementation of data filtering based on historical data analysis in accordance with an illustrative embodiment. Application 402 is an example of application 105 in FIG. 1 and application 302 in FIG. 3. Database 418 is an example of database 316 in FIG. 3 and database 109 in FIG. 1. Graphical user interface 404 is an example of graphical user interface 314 in FIG. 3.

Graphical user interface 404 displays multiple user input fields such as entity type 406, entity activities 408, entity assets 410, and entity description 412. In one embodiment, entity type 406 may include the size of the entity which can be categorized by the number of employees or the size of the revenue. Entity activities 408 may include activities performed by the entity. Activities of an entity may include types of business operations in which the entity participates. Entity assets 410 may include products and services provided by the entity. Entity description 412 may include a text description providing different aspects of the entity.

Once graphical user interface 404 receives user input, application 402 identifies a set of documents in accordance with the entity information. In several embodiments, application 402 accesses database to identify documents previously identified for previous entity information and may construct a database query based on keywords extracted from the user input. Based on the identified documents, application 402 determines a set of task items to be tagged or linked to the documents based on the content of the documents. In several embodiments, application 402 may access database 418 previous task items linked with similar documents. Alternatively, application 402 may construct a task item database query by extracting keywords from the identified documents. After all the task items are determined, application 402 associates the task items to the corresponding document within the set of identified documents. At this point, graphical user interface 404 may display the documents, such as document 414, identified through user input along with the task items, such as task items 416A, 416B, and 416C, associated with each of the identified documents. In some embodiments, graphical user interface 404 provides an option for the user to select or deselect task items that ensure only relevant data is applied for further analysis. For example, task item 416C remains unselected whereas task items 416A and 416B are selected since they appear relevant to the entity based on the entity information entered through user input in graphical user interface 404.

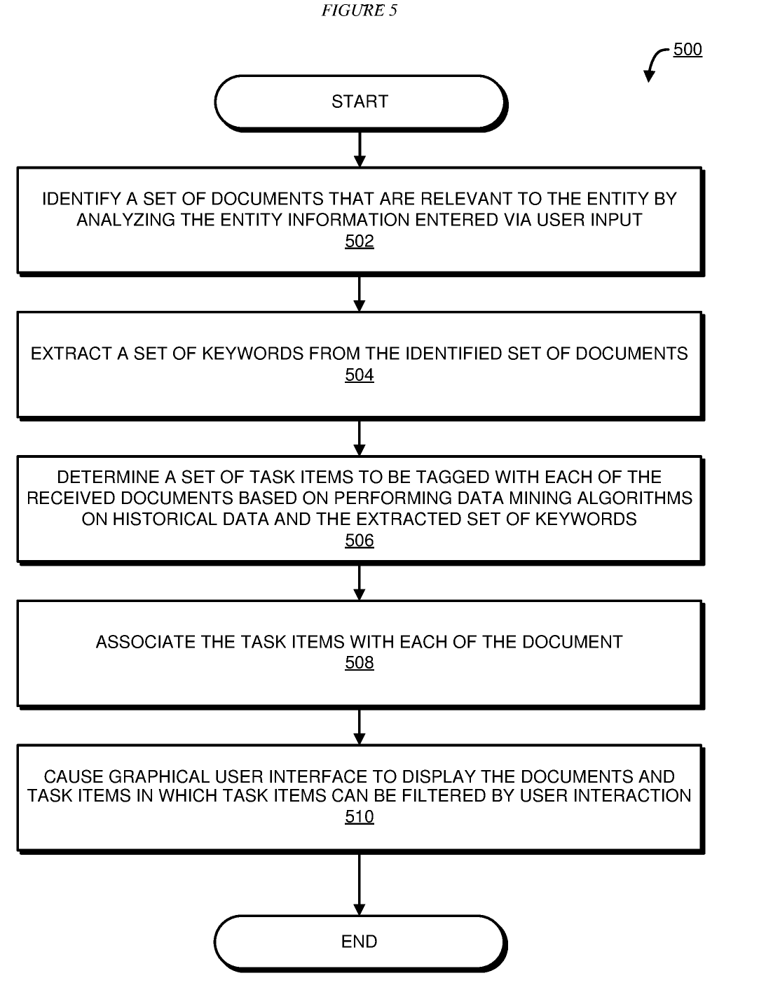

With reference to FIG. 5, this figure depicts a flowchart of an example process for data filtering based on historical data analysis in accordance with an illustrative embodiment. Process 500 may be implemented in application 302 in FIG. 3.

The application identifies a set of documents that are relevant to the entity by analyzing the entity information entered via user input (block 502). The application extracts a set of keywords from the identified set of documents (block 504). The application determines a set of task items to be tagged with each of the received documents based on performing data mining algorithms on historical data and the extracted set of keywords (block 506). The application associates the task items with each of the document (block 508). The application causes graphical user interface to display the documents and task items in which task items can be filtered by user interaction (block 510). Process 500 terminates thereafter.

Thus, a computer implemented method, system or apparatus, and computer program product are provided in the illustrative embodiments for merging two documents that may contain different perspectives and/or bias. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of data filtering based on historical data analysis, the method comprising:
identifying, by one or more processors, a first document based on keywords extracted from input;
converting, by one or more processors, the first document into a multi-dimensional vector based on analyzing a set of features of the first document;
assigning, by one or more processors, the multi-dimensional vector to at least one machine learning cluster, wherein the at least one machine learning cluster is formed based on historical data derived from previously processed documents;
retrieving, by one or more processors, a set of task items linked to the at least one machine learning cluster; and
associating, by one or more processors, the set of task items to the first document.

2. The method according to claim 1, wherein identifying the first document further comprises:
constructing, by one or more processors, a first database query based on the keywords extracted from the input; and
retrieving, by one or more processors, a plurality of candidate documents based on the first database query.

3. The method according to claim 2, further comprising:
determining, by one or more processors, that a total count of the plurality of the candidate documents exceed a threshold value; and
constructing, by one or more processors, a second database query based on the keywords extracted from the input, wherein syntax of the second database query is more restrictive than syntax of the first database query.

4. The method according to claim 1, further comprising:
causing, by one or more processors, a graphical user interface to display the first document and the set of task items associated therewith, wherein at least one task item of the set of task items can be filtered through user interaction with the graphical user interface.

5. The method according to claim 1, wherein the input comprises entity information data consisting of entity type, entity activities, entity assets, entity description, and combinations thereof.

6. The method according to claim 1, wherein the step of associating the set of task items further comprises:
converting, by one or more processors, the set of task items into a set of pointer values; and
linking, by one or more processors, the set of pointer values to the first document.

7. The method according to claim 1, further comprising:
generating, by one or more processors, a decision tree data structure based on the historical data; and
performing, by one or more processors, a traversal of the generated decision tree data structure of the first document to identify a second set of task items linked to a child node of the decision tree data structure.

8. A computer program product for data filtering based on historical data analysis, the computer program product comprising one or more computer readable storage medium and program instructions stored on at least one of the one or more computer readable storage medium, the program instructions comprising:
program instructions to identify a first document based on keywords extracted from input;
program instructions to convert the first document into a multi-dimensional vector based on analyzing a set of features of the first document;
program instructions to assign the multi-dimensional vector to at least one machine learning cluster, wherein the at least one machine learning cluster is formed based on historical data derived from previously processed documents;
program instructions to retrieve a set of task items linked to the at least one machine learning cluster; and
program instructions to associate the set of task items to the first document.

9. The computer program product according to claim 8, wherein program instructions to identify the first document further comprises:
program instructions to construct a first database query based on the keywords extracted from the input; and
program instructions to retrieve a plurality of candidate documents based on the first database query.

10. The computer program product according to claim 9, further comprising:
program instructions to determine that a total count of the plurality of the candidate documents exceed a threshold value; and
program instructions to construct a second database query based on the keywords extracted from the input, wherein syntax of the second database query is more restrictive than syntax of the first database query.

11. The computer program product according to claim 8, further comprising:
program instructions to cause a graphical user interface to display the first document and the set of task items associated therewith, wherein at least one task item of the set of task items can be filtered through user interaction with the graphical user interface.

12. The computer program product according to claim 8, wherein the input comprises entity information data consisting of entity type, entity activities, entity assets, entity description, and combinations thereof.

13. The computer program product according to claim 8, wherein program instructions to associate the set of task items further comprises:
program instructions to convert the set of task items into a set of pointer values; and
program instructions to link the set of pointer values to the first document.

14. The computer program product according to claim 8, further comprising:
program instructions to generate a decision tree data structure based on the historical data; and
program instructions to perform a traversal of the generated decision tree data structure of the first document to identify a second set of task items linked to a child node of the decision tree data structure.

15. A computer system for data filtering based on historical data analysis, the computer system comprising one or more processors, one or more computer readable memories, one or more computer readable storage medium, and program instructions stored on at least one of the one or more storage medium for execution by at least one of the one or more processors via at least one of the one or more memories, the program instructions comprising:
program instructions to identify a first document based on keywords extracted from input;
program instructions to convert the first document into a multi-dimensional vector based on analyzing a set of features of the first document;
program instructions to assign the multi-dimensional vector to at least one machine learning cluster, wherein the at least one machine learning cluster is formed based on historical data derived from previously processed documents;
program instructions to retrieve a set of task items linked to the at least one machine learning cluster; and
program instructions to associate the set of task items to the first document.

16. The computer system according to claim 15, wherein program instructions to identify the first document further comprises:
program instructions to construct a first database query based on the keywords extracted from the input; and
program instructions to retrieve a plurality of candidate documents based on the first database query.

17. The computer system according to claim 16, further comprising:
program instructions to determine that a total count of the plurality of the candidate documents exceed a threshold value; and
program instructions to construct a second database query based on the keywords extracted from the input, wherein syntax of the second database query is more restrictive than syntax of the first database query.

18. The computer system according to claim 15, further comprising:
program instructions to cause a graphical user interface to display the first document and the set of task items associated therewith, wherein at least one task item of the set of task items can be filtered through user interaction with the graphical user interface.

19. The computer system according to claim 15, wherein the input comprises entity information data consisting of entity type, entity activities, entity assets, entity description, and combinations thereof.

20. The computer system according to claim 15, further comprising:
program instructions to generate a decision tree data structure based on the historical data; and
program instructions to perform a traversal of the generated decision tree data structure of the first document to identify a second set of task items linked to a child node of the decision tree data structure.
